(19) United States
(12) Patent Application Publication
(10) Pub. No.: US 2020/0082281 A1
(43) Pub. Date: Mar. 12, 2020

(54) VERIFICATION DEVICE

(71) Applicant: FANUC Corporation, Yamanashi (JP)

(72) Inventor: Yasuhiro SHIBASAKI, Yamanashi (JP)

(21) Appl. No.: 16/546,301

(22) Filed: Aug. 21, 2019

(30) Foreign Application Priority Data
Sep. 12, 2018 (JP) 2018-170951

(51) Int. Cl. G06N 5/04; G06N 20/00

(52) U.S. Cl. CPC G06N 5/04; G06N 20/00

(57) ABSTRACT

A verification device for verifying validity of stored learning data generates a learning model by learning based on the learning data, performs inference using the learning model based on the learning data, further, analyzes the learning data using a result of reference in accordance with an analysis scheme for analyzing the learning data and an analysis specification defining a criterion in analysis, and processes the learning data in accordance with a result of the analysis.

### RELATED APPLICATIONS

The present application claims priority to Japanese Patent Application Number 2018-170951 filed Sep. 12, 2018, the disclosure of which is hereby incorporated by reference herein in its entirety.

### BACKGROUND OF THE INVENTION

### 1. Field of the Invention

The present invention relates to a verification device, and particularly relates to a verification device that performs verification related to learning of a machine learning device used at a manufacturing site such as a factory.

### 2. Description of the Related Art

At a manufacturing site such as a factory, data has been collected from a lot of machine tools or industrial machines such as robots installed at the manufacturing site to automate a process such as classification, regression, and abnormality detection based on the collected data by applying machine learning such as supervised learning (for example, see Japanese Patent Application Laid-Open No. 2017-162252 and Japanese Patent Application Laid-Open No. 2018-077757). In general, since performance of inference, etc. of a machine learning device depends on the quality of learning data using learning, a large amount of learning data dedicated to each task is prepared in many cases.

However, when inference processing is performed using a machine learning device which has finished learning, a result different from a result previously presumed may be output. In such a case, it is necessary to analyze a cause for erroneous learning to make an improvement so that the presumed result is obtained. However, in general, in the machine learning device, a lot of parameters are interrelated to draw ah inference, and thus manual analysis and improvement are difficult.

In addition, abnormal data is included in data collected as learning data in many cases. When learning is performed using such learning data, the machine learning device may output a result different from a presumed result. However, even when analysis is performed to extract abnormal data from learning data using learning, since a large amount of learning data is used for learning, manual analysis, etc. is difficult to perform. Further, in particular, learning data used for supervised learning is manually tagged (specification design, tagging, etc.). However, since subjectivity of an operator performing tagging cannot be completely excluded, there is also a problem that it is difficult to secure consistency and repeatability of a tag assigned to learning data.

### SUMMARY OF THE INVENTION

Therefore, an object of the present invention is to provide a verification device that performs verification related to learning of a machine learning device used at a manufacturing site such as a factory.

The present invention solves the above-mentioned problem by implementing a function of analyzing a distribution of an inference result of learning data used for learning of a machine learning device used in an industrial machine installed in a factory, etc. and detecting a difference from a result presumed in advance, thereby automatically detecting and correcting errors in the learning data (an outlier, excess or deficiency of a tag, and erroneous tagging).

A verification device according to the present invention verifies validity of learning data stored in a learning data storage unit and includes a learning unit for generating a learning model by learning based on the learning data stored in the learning data storage unit, an inference unit for performing inference using the learning model based on the learning data stored in the learning data storage unit, an analysis unit for analyzing the learning data stored in the learning data storage unit using a result of reference of the inference unit in accordance with an analysis scheme for analyzing the learning data stored in the learning data storage unit and an analysis specification defining a criterion in the analysis, and a processing unit for processing the learning data stored in the learning data storage unit in accordance with a result of analysis by the analysis unit.

The analysis specification may define a threshold value for extracting abnormal data from the learning data stored in the learning data storage unit using a result of inference by the inference unit, the analysis unit may extract abnormal data from the learning data stored in the learning data storage unit in accordance with the analysis specification, and the processing unit may remove abnormal data extracted by the analysis unit from the learning data storage unit.

The analysis specification may define a threshold value of reliability as a result of inference by the inference unit related to the learning data stored in the learning data storage unit, the analysis unit may extract learning data having low reliability from the learning data stored in the learning data storage unit in accordance with the analysis specification, and the processing unit may assign a new tag different from a tag assigned to the learning data stored in the learning data storage unit to the data having the low reliability extracted by the analysis unit.

According to the present invention, by removing learning data that causes an inference result deviated from a preset criterion, and automatically performing learning inference again, it is possible to contribute to analysis and improvement for improving accuracy. In addition, when distribution of inference results of a part having the same tag in learning data is split up, it is possible to construct a machine learning device having a tag closer to an actual state by automatically reassigning a new tag for each distribution and performing learning inference.

### BRIEF DESCRIPTION OF THE DRAWINGS

FIG. 1 is a schematic hardware configuration diagram of a verification device according to an embodiment; and

FIG. 2 is a schematic functional block diagram of the verification device according to the embodiment.

### DETAILED DESCRIPTION OF THE PREFERRED EMBODIMENTS

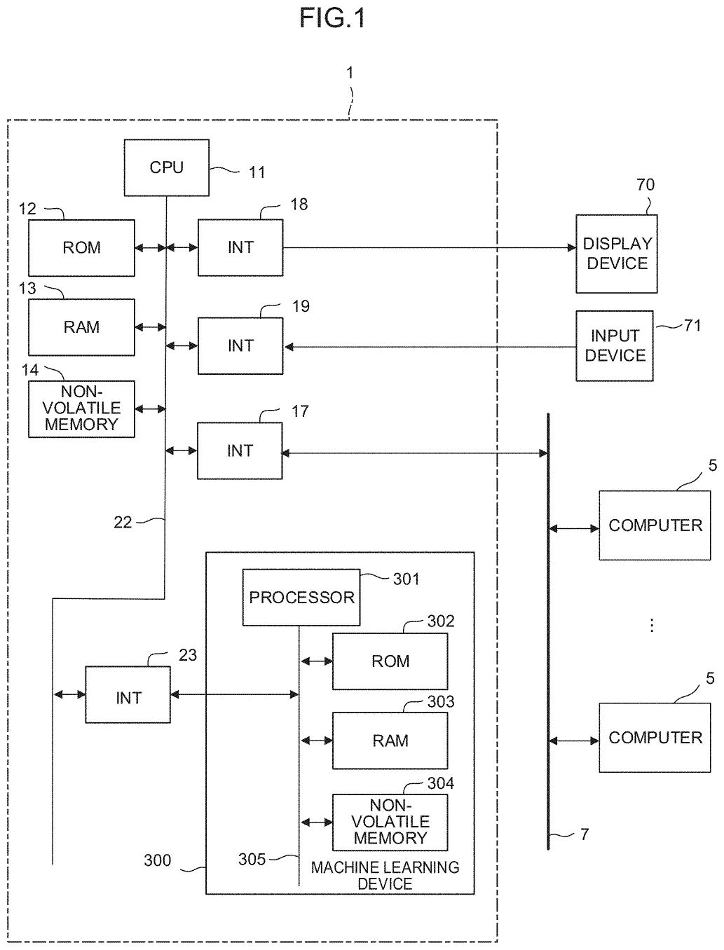

FIG. 1 is a schematic hardware configuration diagram illustrating a main part of a verification device according to an embodiment of the present invention.

The verification device 1 of the present embodiment can be mounted as a computer installed at a manufacturing site such as a factory, or mounted as a computer such as an edge computer, a cell computer, a host computer, or a cloud server connected to the computer installed at the manufacturing site such as the factory via a network. FIG. 1 illustrates an example in a case in which the verification device 1 is mounted as the computer installed at the manufacturing site such as the factory.

A CPU 11 included in the verification device 1 according to the present embodiment is a processor that controls the verification device 1 as a whole. The CPU 11 reads a system program stored in a ROM 12 connected via a bus 22 and controls the entire verification device 1 in accordance with the system program. A RAM 13 stores temporary calculation data, display data to be displayed on a display device 70, various data input by an operator via an input device 71, etc.

A non-volatile memory 14 includes, for example, an SRAM, an SSD, etc. backed up by a battery (not illustrated), and is configured as a memory kept in a storage state even when power of the verification device 1 is turned off. Data or a program input via the input device 71, data acquired from another computer 5 (a controller, a host computer, etc.) connected to a network 7 via an interface 17, etc. are stored in the non-volatile memory 14. The data, the program, etc. stored in the non-volatile memory 14 may be loaded in the RAM 13 during use. In addition, various algorithms required for analysis of data and a system program for executing other required processes are written to the ROM 12 in advance.

The interface 17 is an interface for connecting the verification device 1 to the wired/wireless network 7. A controller for controlling a machine tool installed in a factory, the computer 5 such as a personal computer, an edge computer, a cell computer, or a host computer, etc. are connected to the network 7 to mutually exchange information via the network 7.

An interface 23 is an interface for connecting the verification device 1 and a machine learning device 300 to each other. In the machine learning device 300, a processor 301 that controls the entire machine learning device 300, a ROM 302 storing a system program, etc., a RAM 303 for performing temporary storage in each process related to machine learning, a non-volatile memory 304 used to store a learning model, etc. are connected via a bus 305. The machine learning device 300 can observe each piece of information that can be acquired by the verification device 1 via the interface 23. Further, the verification device 1 performs subsequent processing based on estimation of a verification result on an inspection target output from the machine learning device 300.

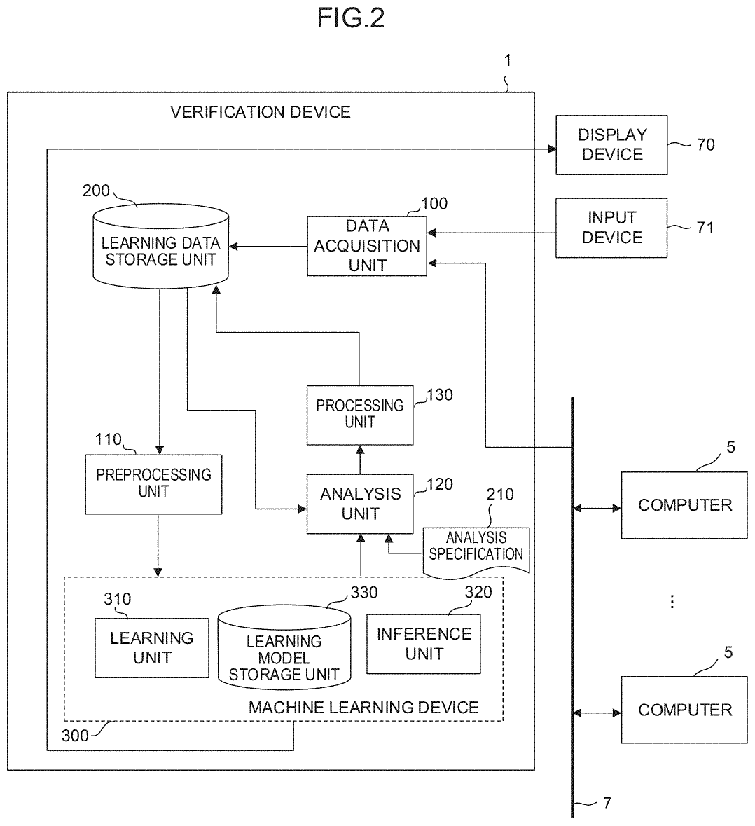

FIG. 2 is a schematic functional block diagram of the verification device 1 and the machine learning device 300 according to a first embodiment.

Each functional block illustrated in FIG. 2 is realized when the CPU 11 included in the verification device 1 and the processor 301 of the machine learning device 300 illustrated in FIG. 1 execute respective system programs to control operation of each unit of the verification device 1 and the machine learning device 300.

The verification device 1 according to the present embodiment includes a data acquisition unit 100, a preprocessing unit 110, an analysis unit 120, and a processing unit 130, and the machine learning device 300 included in the verification device 1 includes a learning unit 310 and an inference unit 320. In addition, on the non-volatile memory 14, a learning data storage unit 200 that stores data used for learning and inference by the machine learning device 300 is provided, and an analysis specification 210 related to learning data is set. Furthermore, a learning model storage unit 330 that stores a learning model constructed by machine learning by the learning unit 310 is provided on the non-volatile memory 304 of the machine learning device 300.

The data acquisition unit 100 acquires various data used as learning data from the input device 71, another computer 5, etc. For example, the data acquisition unit 100 acquires data (such as signal data and image data) detected in a work process in an industrial machine (not illustrated), label data indicating a result of visual inspection of the acquired data by the operator (as appropriate), learning data acquired from another computer 5, etc. from the computer 5 as a controller that controls the industrial machine in accordance with an instruction of the operator, and stores the acquired data in the learning data storage unit 200. The data acquisition unit 100 may acquire data from an external storage device (not illustrated).

The preprocessing unit 110 creates data to be used for learning or inference by the machine learning device 300 based on the learning data stored in the learning data storage unit 200. For example, the preprocessing unit 110 creates state data S used for learning when the machine learning device 300 performs unsupervised learning based on learning data stored in the learning data storage unit 200. For example, the preprocessing unit 110 creates teacher data corresponding to a set of state data S and label data L used for learning when the machine learning device 300 performs supervised learning, based on learning data stored in the learning data storage unit 200. Alternatively, for example, the preprocessing unit 110 creates state data S used for inference using a learning model in the machine learning device 300, based on learning data stored in the learning data storage unit 200. The preprocessing unit 110 creates state data S and label data L by converting (digitizing, normalizing, sampling, etc.) the acquired data into a uniform format to be handled in the machine learning device 300.

The state data S created by the preprocessing unit 110 may be, for example, array data of pixel values included in an image obtained by imaging a product manufactured by the industrial machine. Further, the state data S created by the preprocessing unit 110 may be, for example, array data including a speed value or a torque value of each axis, a current value, and a voltage value acquired from the industrial machine and physical data of a sensor, etc. detected by a voice sensor, etc.

In addition, the label data L created by the preprocessing unit 110 may be, for example, a label that classifies a product manufactured by the industrial machine into a non-defective product and a defective product, or classifies an operating state of the industrial machine into an normal operation state or an abnormal operation state.

The state data S and the label data L may have various formats in accordance with a purpose or a learning method of learning by the machine learning device 300, a type of a learning model, etc.

The learning unit 310 performs machine learning using the data created by the preprocessing unit 110, and generates (learns) a learning model as a learning result. In unsupervised learning, the learning unit 310 performs learning using the state data S created by the preprocessing unit 110. In supervised learning, the learning unit 310 performs learning using the teacher data (the state data S and label data L) created by the preprocessing unit 110. The learning unit 310 may be configured to perform supervised learning using, for example, a neural network as a learning model. In such a configuration, a neural network having three layers of an input layer, an intermediate layer, and an output layer may be used as the learning model. However, more effective learning and inference may be performed using a so-called deep learning scheme using a neural network forming three or more layers. In addition, the learning unit 310 may perform learning using, for example, a regression model or various other known learning models such as an SVM, an isolation forest, a random forest, and a local outlier factor. The learning model generated by the learning unit 310 is stored in the learning model storage unit 330 provided on the non-volatile memory 304, and used for inference processing by the inference unit 320.

The inference unit 320 performs inference processing using the learning model stored in the learning model storage unit 330, based on the state data S input from the preprocessing unit 110. The inference unit 320 performs arithmetic processing using the state data S input from the preprocessing unit 110 as Input data, using the learning model (in which the parameter is determined) generated by learning by the learning unit 310, thereby outputting a result inferred from the input data. The result inferred by the inference unit 320 is, for example, output to the analysis unit 120 and used for analysis. Besides, the result may be used by being displayed and output on the display device 70 or by being transmitted and output to another computer 5 such as the host computer or the cloud computer via the network 7.

The analysis unit 120 analyzes the learning data stored in the learning data storage unit 200 in accordance with the analysis specification 210. The analysis specification 210 is a specification that defines an analysis scheme for analyzing learning data and a reference in the analysis, and is set in a setting area of the verification device 1 provided on the non-volatile memory 14 by the operator through the input device 71 in advance. Examples of the analysis specification 210 include a method of extracting abnormal data in learning data, a threshold value in the extraction method, etc. Examples of the analysis specification 210 include (a) extracting, from among pieces of data which deviate from any of clusters (or which have distances from any of the clusters) when a cluster set is generated, n percent pieces of data in the order of height of degree of the deviation, as abnormal data, (b) extracting, as abnormal data, learning data in which a ratio of the surrounding density in a learning data space to the surrounding density of surrounding learning data is less than a predetermined ratio r, (c) extracting, as abnormal data, data in which reliability of an inference result by the learning model is less than m, etc. Using an inference result by the inference unit 320 using the learning data stored in the learning data storage unit 200 as input data, the analysis unit 120 extracts abnormal data from the learning data in accordance with the set analysis specification 210.

The processing unit 130 processes the learning data stored in the learning data storage unit 200 based on an analysis result of the learning data by the analysis unit 120 which is stored in the learning data storage unit 200. For example, the processing unit 130 may perform processing to remove data extracted as abnormal data from the learning data, or assign a tag other than a tag assigned to current learning data stored in the learning data storage unit 200 to the data extracted as the abnormal data. For example, the processing unit 130 may display a list of learning data extracted as abnormal data on the display device 70, and prompt the operator to command processing to be performed on the abnormal data. In this case, the processing unit 130 performs processing on the abnormal data extracted from the learning data stored in the learning data storage unit 200 based on the command from the operator via the input device 71.

Hereinafter, examples of processing performed by the analysis unit 120 and the processing unit 130 will be shown.

In a first example of the processing performed by the analysis unit 120 and the processing unit 130, unsupervised learning (isolation forest) which uses, as learning data, a two-dimensional (2D) image obtained by imaging the metal smartphone case is performed in quality inspection of metal smartphone cases before shipping, and automatic inspection of products is performed using the learning model as a learning result.

In this instance, 2D image data obtained by imaging a lot of products to create a learning model is acquired by the data acquisition unit 100 and stored in the learning data storage unit 200 as learning data, and 2D images of a large number of non-defective products and 2D images of a small number of defective products are mixed in the data. In general, in the case of generating a learning model for classification by unsupervised learning, accuracy of inference can be improved by using learning data of only non-defective products. However, to this end, it is necessary to separate non-defective products and defective products by manually verifying the learning data in advance. In the verification device 1 of the present embodiment, this process can be substantially automated.

First, learning (isolation forest) is performed by the earning unit 310 using the learning data stored in the learning data storage unit 200 to construct a temporary learning model. Subsequently, by performing inference processing by the inference unit 320 on each learning data based on the constructed learning model, a degree of abnormality with respect to each learning data is inferred. The analysis unit 120 extracts an upper n percent portion (defined in the analysis specification based on a normal defective rate estimated in advance at the manufacturing site) as abnormal data based on the degree of abnormality (a degree of deviation of the learning data in a set of learning data) for each learning data inferred as described above. Then, the processing unit 130 removes abnormal data extracted as a result of analysis by the analysis unit 120 from the learning data storage unit 200. Thereafter, the learning unit 310 generates a learning model again using the learning data left in the learning data storage unit 200. In this way, since manual pre-selection of learning data is unnecessary, operation efficiency is improved. In addition, it is possible to improve performance of automated inspection by removing abnormal data.

In a second example of the processing performed by the analysis unit 120 and the processing unit 130, unsupervised learning (local outlier factor) which uses, as learning data, vibration data or sound data detected during operation of the machine tool is performed in fault diagnosis of the machine tool, and a fault state of the machine tool is automatically diagnosed using a learning model as a learning result.

In this instance, vibration data or sound data is acquired by the data acquisition unit 100 from sensors attached to a lot of machine tools in order to create a learning model, and is stored in the learning data storage unit 200 as learning data. In the data, a large number of pieces of vibration data or sound data detected in a normal state and a small number of pieces of vibration data or sound data detected in a fault state are mixed. In general, in the case of generating a learning model for classification by unsupervised learning, accuracy of inference can be improved by using only learning data in the normal state. However, to this end, it is necessary to distinguish between a normal state and a fault state by manually verifying the learning data in advance. In the verification device 1 of the present embodiment, this process can be substantially automated.

First, learning (local outlier factor) is performed by the learning unit 310 using the learning data stored in the learning data storage unit 200 to construct a temporary learning model. Subsequently, inference processing by the inference unit 320 is performed on each learning data based on the constructed learning model. In this way, with respect to each learning data, a ratio of the surrounding density of the learning data in a learning data space to the surrounding density of surrounding learning data is inferred.

The analysis unit 120 extracts, as abnormal data, learning data in which a ratio of the surrounding density of each learning data to the surrounding density of surrounding learning data inferred in this way (a degree of deviation with respect to the surrounding learning data) is less than a predetermined ratio r (defined in the analysis specification). Then, the processing unit 130 removes, from the learning data storage unit 200, abnormal data extracted as a result of analysis by the analysis unit 120. Thereafter, the learning unit 310 generates a learning model again using the learning data left in the learning data storage unit 200. In this way, since manual pre-selection of learning data is unnecessary, operation efficiency is improved. In addition, it is possible to improve performance of automatic inspection by removing abnormal data.

In a third example of the processing performed by the analysis unit 120 and the processing unit 130, supervised learning (random forest) using a 2D image obtained by imaging the metal smartphone case as learning data is performed in scratch mode inspection of the metal smartphone case before shipment, and automatic inspection of a scratch mode of a product is performed using a learning model as a learning result.

In this instance, a scratch mode (scrape, cut, etc.) presumed in advance is identified, 2D image data obtained by imaging a large number of products to create a learning model is acquired by the data acquisition unit 100, and learning data in which information indicating whether a product is a non-defective product or indicating a scratch mode into which a product is classified is assigned, as a label, to each acquired data is stored in the learning data storage unit 200 as learning data. However, in this case, since it is difficult to determine a quantitative classification criterion for the scratch mode, tagging tends to be vague. As a result, there is a problem that the quality of automatic diagnosis tends to vary. In the verification device 1 of the present embodiment, by contrast, validity of a tag used for the classification can be almost automatically verified.

First, learning (random forest) is performed by the learning unit 310 using (temporarily labeled) learning data stored in the learning data storage unit 200 to construct a temporary learning model. Subsequently, by performing inference processing by the inference unit 320 on each learning data based on the constructed learning model, classification on each learning data and reliability thereof are inferred. The analysis unit 120 extracts data whose reliability is less than m (defined in the analysis specification) as data to which abnormality tag is assigned based on classification and reliability (a degree of reliability at which learning data belongs to the classification) with respect to each learning data inferred in this way. Then, the processing unit 130 assigns a new tag (for example, a scratch mode A, etc.) again to the learning data in the learning data storage unit 200 assigned with abnormality tag extracted as a result of the analysis by the analysis unit 120. Thereafter, the learning unit 310 generates a temporary learning model again using the learning data left in the learning data storage unit 200, the above process is repeated until all the learning data have a reliability of m or more, and a learning model at the time when all the learning data have a reliability of m or more is used as a learning model used for automatic inspection of the scratch mode of the product. In this way, it is possible to determine a classification criterion according to a possible scratch mode in learning data, and it is possible to improve performance of automatic inspection.

As mentioned above, even though the embodiment of the present invention has been described, the present invention can be implemented in various aspects by adding an appropriate change without being limited only to examples of the embodiment mentioned above.

1. A verification device for verifying validity of learning data stored in a learning data storage unit, the verification device comprising:
a learning unit for generating a learning model by learning based on the learning data stored in the learning data storage unit;
an inference unit for performing inference using the learning model based on the learning data stored in the learning data storage unit;
an analysis unit for analyzing the learning data stored in the learning data storage unit using a result of reference of the inference unit in accordance with an analysis scheme for analyzing the learning data stored in the learning data storage unit and an analysis specification defining a criterion in the analysis; and
a processing unit for processing the learning data stored in the learning data storage unit in accordance with a result of analysis by the analysis unit.

2. The verification device according to claim 1,
wherein the analysis specification defines a threshold value for extracting abnormal data from the learning data stored in the learning data storage unit using a result of inference by the inference unit,
the analysis unit extracts abnormal data from the learning data stored in the learning data storage unit is accordance with the analysis specification, and
the processing unit removes abnormal data extracted by the analysis unit from the learning data storage unit.

3. The verification device according to claim 1,
wherein the analysis specification defines a threshold value of reliability as a result of inference by the inference unit related to the learning data stored in the learning data storage unit,
the analysis unit extracts learning data having low reliability from the learning data stored in the learning data storage unit is accordance with the analysis specification, and
the processing unit assigns a new tag different from a tag assigned to the learning data stored in the learning data storage unit to the data having the low reliability extracted by the analysis unit.
